(19) United States
(12) Patent Application Publication
(10) Pub. No.: US 2017/0213219 A1
(43) Pub. Date: Jul. 27, 2017

(54) METHOD AND SYSTEM FOR AUTOMATED MANAGEMENT OF DYNAMIC CURRENCY CONVERSION

(71) Applicant: Mastercard International Incorporated, Purchase, NY (US)

(72) Inventor: John Paul GARDEN, Edinburgh (GB)

(73) Assignee: Mastercard International Incorporated, Purchase, NY (US)

(21) Appl. No.: 15/414,847

(22) Filed: Jan. 25, 2017

Related U.S. Application Data
(60) Provisional application No. 62/286,497, filed on Jan. 25, 2016.

(51) Int. Cl. G06Q 20/40; G06Q 40/02; G06Q 20/10; G06Q 20/32; G06F 17/30; H04W 4/02

(52) U.S. Cl. CPC G06Q 20/407; G06F 17/30477; G06F 17/30312; G06F 17/30241; H04W 4/02; G06Q 20/102; G06Q 20/3223; G06Q 40/02; G06Q 20/3226

(57) ABSTRACT

A method for automated management of dynamic currency conversion in a cross-border transaction includes: storing an account profile including a primary account number, identification value, a first transaction control associated with a home geographic location, and a second transaction control associated with a home currency; receiving a travel notification including the identification value and a second geographic location; updating the transaction controls in the account profile to be associated with the second geographic location and an associated local currency; receiving a transaction message from an acquiring institution including the primary account number, a transacting geographic location, and a transacting currency; evaluating, the transaction geographic location and currency for correspondence to the second geographic location and local currency; and transmitting the transaction message to an issuing financial institution if the evaluation is successful or a second transaction message to the acquiring institution if the evaluation is unsuccessful.

### FIELD

The present disclosure relates to the automated management of dynamic currency conversion in a cross-border transaction, specifically the use of a specialized processing system for ensuring that dynamic currency conversion is not used unless pre-authorized by the account holder via transaction controls on the geographic location and currency used in a transaction.

### BACKGROUND

Consumers and business entities can find a lot of benefit in using payment cards to conduct transactions. In many instances, payment cards and other similar payment instruments are used for both convenience and security, as they enable transactions to be conducted without carrying around paper currency. In the case of large businesses, payment cards can serve as a useful way to monitor and control spending on a business account by employees.

In most circumstances, a payment card or other payment instrument is used in transactions that are processed using a currency associated with a home geographic location, typically a country, where the card or other instrument was issued. In order to continue the convenience provided by such instruments, dynamic currency conversion (DCC) was created. Dynamic currency conversion is a process where a transaction can be conducted in a location where the local currency differs from the instrument's home currency, with an exchange rate being automatically applied such that the transaction is processed in the home currency. In many instances, the consumer is able to select at the point of sale whether to use DCC, or to have the transaction processed in the local currency with a currency exchange performed later on.

While DCC may provide convenience to many consumers and business entities, there can be several disadvantages. In many instances, the exchange rate provided via DCC is above the market exchange rate and not favorable to the consumer or their issuing financial institution, resulting in a higher payment than if the transaction was processed without DCC. In addition, large entities often have agreements in place with their issuing financial institution regarding foreign exchange rates, which are typically more favorable than market exchange rates, let alone the exchange rates used in DCC. When transactions involving the entity's account are processed using DCC, the entity as well as financial institution may suffer a heavy loss.

Thus, there is a need for a technical solution to enable the option to have cross-border payment transactions to be conducted without the use of dynamic currency conversion. It may often be difficult, and sometimes impossible, for a consumer to decline the use of DCC at a point of sale. In the instance of employees of a large entity, the employees may even be unaware that they are supposed to decline the use of DCC. In such instances, having a technological system designed to give end users or business entities the choice to automate management of the use of DCC in transactions would provide for an added layer of protection to consumers and entities and ensure that DCC is not used in cross-border transactions, which may be additionally useful in instances where the consumer is not provided with an option to decline DCC at the point of sale.

### SUMMARY

The present disclosure provides a description of systems and methods for automated management of dynamic currency conversion in a cross-border transaction.

A method for automated management of dynamic currency conversion in a cross-border transaction includes: storing, in an account database of a processing server, an account profile, wherein the account profile includes a structured data set related to a transaction account including at least a primary account number, an identification value, a first transaction control associated with a home geographic location, and a second transaction control associated with a home currency; receiving, by a receiving device of the processing server, a travel notification, wherein the travel notification includes at least the identification value and a second geographic location different from the home geographic location; executing, by a querying module of the processing server, a query on the account database to update the account profile to modify the first transaction control to be associated with the second geographic location and to modify the second transaction control to be associated with a local currency corresponding to the second geographic location; receiving, by the receiving device of the processing server, a transaction message from an acquiring institution via a payment network, wherein the transaction message is formatted based on one or more standards and includes data related to a payment transaction including at least a plurality of data elements including at least a first data element configured to store the primary account number, a second data element configured to store a transacting geographic location, and a third data element configured to store a transacting currency; evaluating, by a transaction processing module of the processing server, the transaction geographic location and transacting currency for correspondence to the second geographic location and local currency, respectively; and electronically transmitting, by a transmitting device of the processing server, (i) the transaction message to an issuing financial institution associated with the related transaction account if the evaluation is successful, or (ii) a second transaction message to the acquiring institution via the payment network if the evaluation is unsuccessful, wherein the second transaction message includes at least a third data element configured to store a response code indicating that the related payment transaction is declined.

A system for automated management of dynamic currency conversion in a cross-border transaction includes: a transaction processing module of a processing server; a transmitting device of the processing server; an account database of the processing server configured to store an account profile, wherein the account profile includes a structured data set related to a transaction account including at least a primary account number, an identification value, a first transaction control associated with a home geographic location, and a second transaction control associated with a home currency; a receiving device of the processing server configured to receive a travel notification, wherein the travel notification includes at least the identification value and a second geographic location different from the home geographic location; and a querying module of the processing server configured to execute a query on the account database to update the account profile to modify the first transaction control to be associated with the second geographic location and to modify the second transaction control to be associated with a local currency corresponding to the second geographic location. The receiving device of the processing server is further configured to receive a transaction message from an acquiring institution via a payment network, wherein the transaction message is formatted based on one or more standards and includes data related to a payment transaction including at least a plurality of data elements including at least a first data element configured to store the primary account number, a second data element configured to store a transacting geographic location, and a third data element configured to store a transacting currency. The transaction processing module of the processing server is configured to evaluate the transaction geographic location and transacting currency for correspondence to the second geographic location and local currency, respectively. The transmitting device of the processing server is configured to electronically transmit (i) the transaction message to an issuing financial institution associated with the related transaction account if the evaluation is successful, or (ii) a second transaction message to the acquiring institution via the payment network if the evaluation is unsuccessful, wherein the second transaction message includes at least a third data element configured to store a response code indicating that the related payment transaction is declined.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIGS. 1A and 1B are block diagrams illustrating a high level system architecture for the automated management of the use of dynamic currency conversion in cross-border transactions in accordance with exemplary embodiments.

FIG. 2 is a block diagram illustrating the processing server of FIGS. 1A and 1B for the automated management of dynamic currency conversion in cross-border transactions in accordance with exemplary embodiments.

FIG. 3 is a flow diagram illustrating a process for setting up automated management of dynamic currency conversion in cross-border transactions using the system of FIG. 1 in accordance with exemplary embodiments.

FIG. 4 is a flow chart illustrating a process for processing a cross-border transaction that includes automated management of the use of dynamic currency conversion using the processing server of FIG. 2 in accordance with exemplary embodiments.

FIG. 5 is a flow chart illustrating an exemplary method for automated management of dynamic currency conversion in a cross border transaction in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Controlled Payment Number—Controlled payment numbers may be payment numbers associated with a payment account that are subject to one or more rules, also referred to herein as transaction controls. In many cases, these rules or controls may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

Payment Rails—Infrastructure associated with a payment network used in the processing of payment transactions and the communication of transaction messages and other similar data between the payment network and other entities interconnected with the payment network. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

### System for Automated Management of Dynamic Currency Conversion

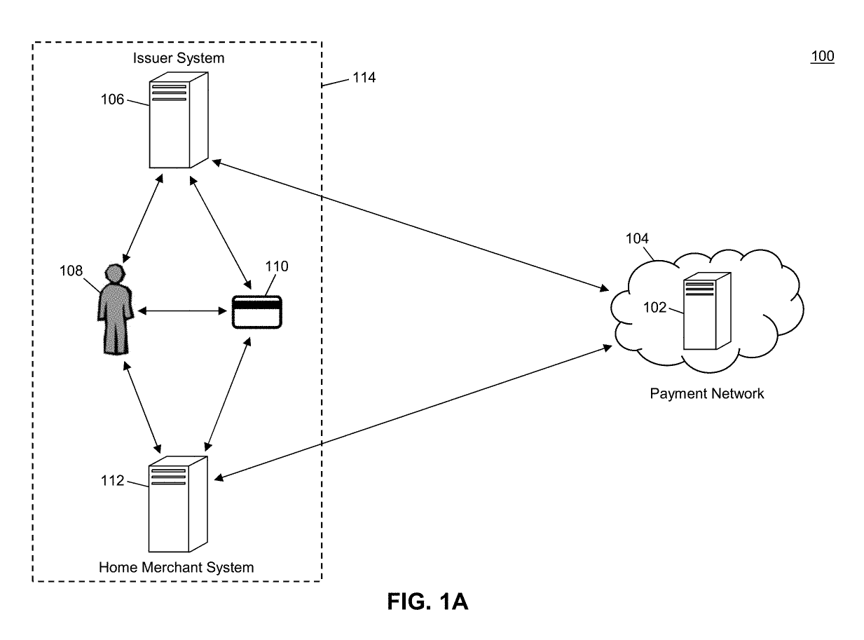

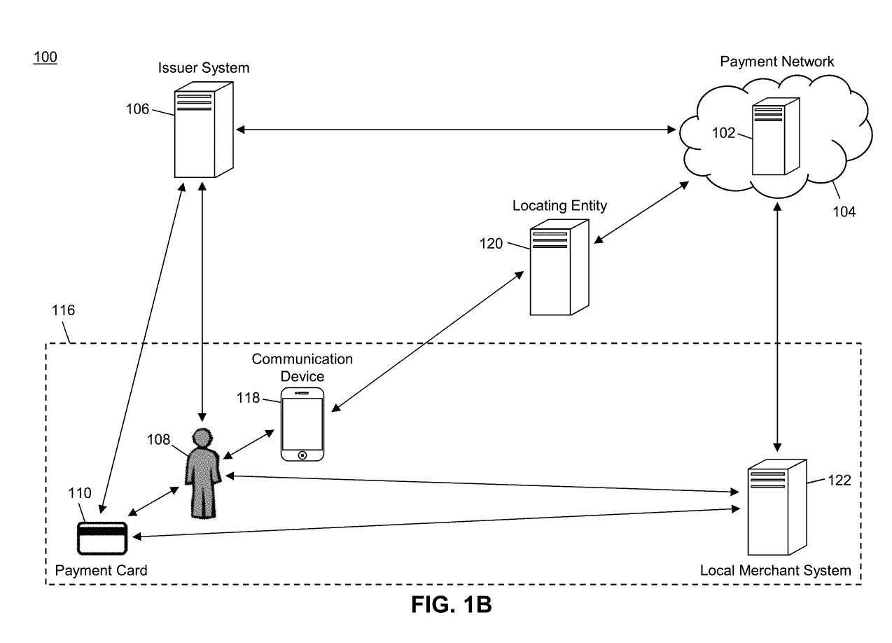

FIGS. 1A and 1 B illustrate a system 100 for the automated management of the use of dynamic currency conversion (DCC) in a cross-border transaction via the use of transaction controls.

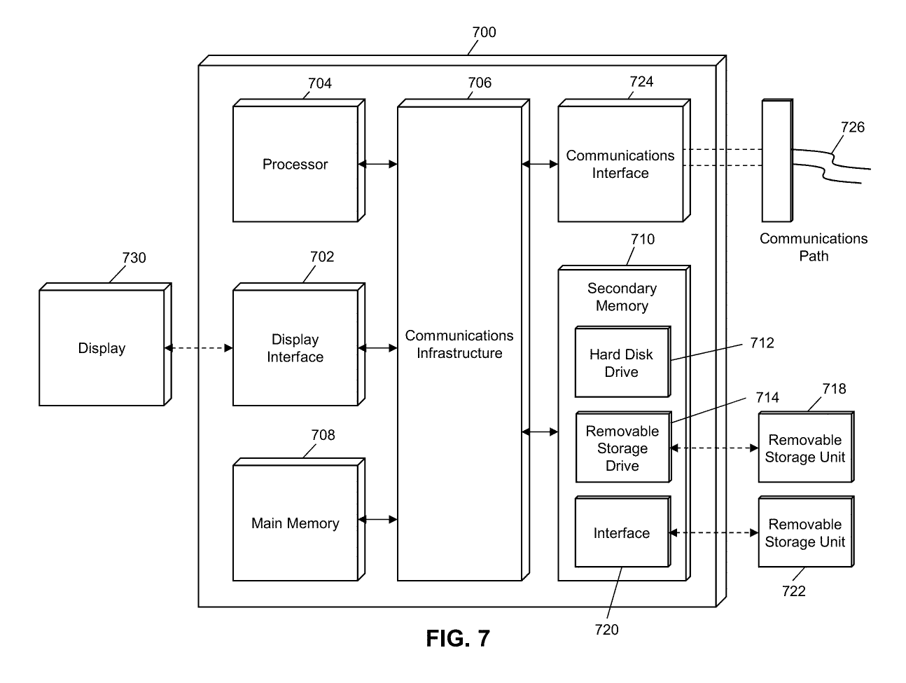

The system 100 may include a processing server 102. The processing server 102, discussed in more detail below, may be configured to automate management of the use of DCC in cross-border transactions via the use of transaction controls associated with a transaction account, applied to the transaction during processing thereof. The processing server 102 may be a part of or may be otherwise in communication with a payment network 104. The payment network 104 may be configured to perform functions associated with the processing of payment transactions and may operate payment rails for the exchange of financial transaction messages, as discussed in more detail below with respect to the process 700 illustrated in FIG. 7.

The system 100 may also include an issuer system 106, which may be a computing system associated with an issuing financial institution, such as an issuing bank, configured to issue transaction accounts for use in funding payment transactions. The issuer system 106 may be used in the issuing of a transaction account to a consumer 108, and may issue a payment card 110 or other suitable payment instrument to the consumer 108 for use in conveying payment details to a merchant for the funding of a payment transaction using the corresponding transaction account. In some instances, the consumer 108 may not be directly associated with the transaction account, such as instances where the consumer 108 may be an employee of an entity that is issued the transaction account, where the payment card 110 issued to the consumer 108 is a card that draws on the entity's transaction account.

In a traditional payment transaction, such as discussed in more detail below with respect to the process 700 illustrated in FIG. 7, the consumer 108 may present the payment card 110 to a home merchant system 112 located in a home geographic location 114 for use in funding the payment transaction. The home merchant system 112 may be a point of sale system or other suitable type of system configured to receive, read, or otherwise obtain payment details from the payment card 110 for use in the processing of a payment transaction. The home geographic location 114 may be a home location associated with the payment card 110 and/or transaction account, where a home currency is used in payment transactions conducted therein. The payment card 110 may be associated with the home currency and home geographic location 114 such that any transaction conducted outside of the home geographic location 114 or with a difference currency is processed as a cross-border transaction. The issuer system 106 may electronically transmit a data signal superimposed or otherwise encoded with data associated with the transaction account, including the home geographic location 114 and home currency, to the processing server 102 via the payment network's payment rails or other suitable communication network and protocols. The processing server 102 may store the data as associated with the transaction account for use in processing transactions involving the transaction account.

In a traditional payment transaction, the home merchant system 112 may electronically transmit transaction details for the payment transaction, which includes payment details associated with the payment card 110, to the payment network 104 via the payment rails. In some instances, the transaction details may be forwarded to the payment network 104 via one or more intermediate entities, such as an acquiring financial institution, gateway processor, etc. The payment network 104 may receive a transaction message for the payment transaction (e.g., directly from the home merchant system 112 or formatted and transmitted by an intermediate entity).

A transaction message may be a specially formatted data message that is formatted pursuant to one or more standards governing the exchange of financial transaction messages, such as the International Organization for Standardization's ISO 8583 standard. The transaction message may include a plurality of data elements configured to store the transaction details, such as a data element configured to store a primary account number associated with the transaction account, a data element configured to store the home geographic location 114 or a location included therein, a data element configured to store a transaction amount, a data element configured to store an indication that the home currency is used, and additional data elements configured to store additional transaction details. The transaction message may also include a bitmap, which may indicate the data elements included therein and what data is stored in each respective data element. The transaction message may also include a message type indicator, indicative of a type for the transaction message. Transaction messages that originate from the transaction details provided by the home merchant system 112 may include a message type indicator indicative of an authorization request.

The payment network 104 may forward the authorization request to the processing server 102. The processing server 102 may identify the data associated with the transaction account involved in the payment transaction that was previously provided by the issuer system 106, which includes at least the home geographic location 114 and home currency. The processing server 102 may evaluate the data stored in the appropriate data elements included in the authorization request to ensure that the geographic location for the transaction is included in the home geographic location 114 of the transaction account and that the payment transaction is being conducted in the home currency. If the evaluation is successful, the authorization request may (e.g., subject to any other transaction controls and other services, such as fraud analysis) be forwarded to the issuer system 106 via the payment network 104 for processing using traditional methods and systems. If the evaluation is unsuccessful, the processing server 102 may generate a return transaction message (e.g., via generation of a new transaction message or modification to the received transaction message), which may include a message type indicator indicative of an authorization response and include a data element configured to store a response code indicating that the transaction was declined. The return transaction message may be electronically transmitted to the home merchant system 112 (e.g., via one or more intermediate entities) using the payment network 104.

The processing server 102 may incorporate the home geographic location 114 and home currency identified for the transaction account by the issuer system 106 as transaction controls. The primary account number associated with the transaction account may thus be a controlled payment number, where all payment transactions involving the transaction account are subject to the transaction controls. The processing server 102 may, as discussed above, evaluate each payment transaction for compliance with the transaction controls, and may decline any payment transaction that is non-compliant with the controls.

The transaction controls associated with location and currency for the transaction account may be used in delivering the option of automated management of the use of DCC for cross-border payment transactions involving the transaction account. The issuer system 106 may register the transaction account for automated management of the transaction account to prohibit the use of DCC in cross-border payment transactions. In some instances, the issuer system 106 may register individual payment cards 110 for the automated management, by providing the processing server 102 with the primary account number associated with each individual payment card 110 that is to be registered. In such embodiments, the issuer system 106 or consumer 108 may register the transaction account and/or payment card 110 prior to the use of such transaction controls to control the use of DCC, such that the processing server 102 may operate herein on an “opt-in” basis for automated management of DCC.

FIG. 1B illustrates the use of the payment card 110 in a cross-border transactions. As illustrated in FIG. 1B, the consumer 108 may travel to a second geographic location 116. The processing server 102 may be notified of the consumer's travel to the second geographic location. In one embodiment, the issuer system 106 may electronically transmit a data signal superimposed with data indicating that the consumer 108 has traveled or is going to travel to the second geographic location 116. In another embodiment, the consumer 108 may possess a communication device 118, which may be used to electronically transmit a data signal to the processing server 102 that indicates that the consumer 108 has traveled or is going to travel to the second geographic location 116. The indication may be submitted using an application program executed by the communication device 118, a web page associated with the processing server 102, electronic or telephonic messaging, or any other suitable method. In some instances, the second geographic location 116 may be self-reported by the consumer 108, or may be automatically identified by the communication device 118 using a suitable method, such as via the global positioning system or cellular network triangulation. The communication device 118 may be any suitable type of communication device, including mobile communication devices, such as a cellular phone, smart phone, laptop computer, tablet computer, notebook computer, smart watch, wearable computing device, implantable computing device, etc.

In yet another embodiment, a locating entity 120 may be used to identify the travel of the consumer 108. The locating entity 120 may be any entity configured to identify the geographic location of a communication device 118 either though self-reporting by the cardholder 108 or cardholder device 118, or by or from a mobile service provider in response to a reported new location via a handoff procedure or the like. For example, the communication device 118 may report its geographic location to the locating entity 120, such as via an application program, via identification of the communication device 118 as connected to a communication network (e.g., a cellular communication network, local area network, wireless network, etc.) included in or associated with the second geographic location 116, etc. The locating entity 120 may then electronically transmit a data signal to the processing server 102 that is superimposed with an indication that the communication device 118 is located in the second geographic location 116. In such instances, the indication may include information identifying the communication device 118, such as a device identifier (e.g., a media access control address, telephone number, registration number, serial number, internet protocol address, etc.), a username, e-mail address, etc., or information identifying the payment card 110 or associated transaction account, such as the primary account number. In the former instance, the communication device 118 or device identifier or other identifying information may be previously registered with the processing server 102, such as via the communication device 118 or issuer system 106.

In some embodiments, the processing server 102 may be notified of the travel of the consumer 108 to the second geographic location 116 via an attempted payment transaction or other usage of the payment card 110 in the second geographic location 116. For example, the consumer 108 may use an automated teller machine, which may electronically transmit a transaction message to the processing server 102 that includes a data element configured to store a geographic location included in or otherwise associated with the second geographic location 116. In such instances, any payment transaction or other type of transaction attempted by the consumer 108 may be declined or prohibited via the transaction controls associated with the payment card 110, which may prevent any transaction occurring outside of the home geographic location 114. In such an instance, the declined transaction may be used as an indication that the consumer 108 has traveled, which may be used in the updating of the associated transaction controls.

Once the processing server 102 has been notified of the travel of the consumer 108 to the second geographic location 116, the processing server 102 may update the transaction controls associated with the transaction account and/or payment card 110 accordingly. The processing server 102 may update the transaction control for the geographic location to include the second geographic location 116 instead of the home geographic location 114. The processing server 102 may also update the transaction control for currency to include a local currency associated with the second geographic location 116 in place of the home currency.

The consumer 108 may then use the payment card 110 in a payment transaction with a local merchant system 122 located in the second geographic location 116. The local merchant system 112 may electronically transmit the transaction details to the payment network 104, which may receive a transaction message for the payment transaction. The transaction message may include at least a data element configured to store a transacting location included in or otherwise associated with the second geographic location 116 and a data element configured to store an indication of the currency being used. In some instances, the transaction message may also include a data element that indicates if DCC is being or was used in the payment transaction.

The transaction message may be forwarded on to the processing server 102, which may evaluate the transaction message for compliance with the transaction controls associated with the payment card 110. The processing server 102 may evaluate the transacting location for compliance with the geographic location transaction control, which may only be successful if the transacting location is included in or associated with the second geographic location 116 as set for the transaction control. The processing server 102 may also evaluate if the currency being used in the transaction is in compliance with the transaction control on currency that prohibits use of any currency aside from the local currency, for example (though other criteria, such as restricting use to only the home currency, for example). In instances where the local currency is the currency being used, the evaluation may be successful and the transaction (e.g., subject to any other controls) continued to be processed. In instances where the local currency is not the currency being used, such as if the home currency is to be used in the processing of the transaction, the evaluation may be unsuccessful and the transaction declined by the processing server 102, such as by returning an authorization response to the local merchant system 112 that includes a data element configured to store a response code indicative of a decline. In some instances, the response code may indicate that the transaction was declined due to a transaction control, and may indicate that it was the currency transaction control, or may indicate that the transaction was declined due to failure to use the local currency. In instances where the authorization request may include a data element configured to store an indication that DCC was used, the processing server 102 may also decline the payment transaction due to use of DCC.

By declining any transaction conducted outside of the home geographic location 114 that does not use the local currency for the geographic location where the payment transaction was conducted, the processing server 102 may prevent the use of DCC in such transactions and ensure that the issuer system 106 or another entity authorized thereby handles the foreign exchange. By automating the updating of transaction controls regarding geographic location and currency, the processing server 102 can ensure that DCC is not used and that transactions are only conducted in a local currency regardless of the travel of a consumer 108. In instances where the geographic location of the consumer 108 is identified via their communication device 118 using automated reporting or reporting via a locating entity 120, the updating may be automatic without participation by the consumer 108, ensuring even greater convenience to the consumer 108. As a result, consumers 108 and entities that do not wish to utilize DCC can travel freely and continue to use their payment card 110 as normal, with any attempts at the use of their home currency when abroad being prevented. This may be additional beneficial in instances where a merchant may not provide the consumer 108 with the opportunity to decline the use of DCC and attempt to process the transaction with the payment card's home currency, as the transaction may be prevented until the merchant complies.

In some embodiments, the consumer 108 may be provided with an opportunity to override the transaction controls. In such an embodiment, when evaluation of compliance with transaction controls for a payment card 110 is unsuccessful, the processing server 102 may electronically transmit a data signal to the communication device 118 associated with the payment card 110 that is superimposed with a request for confirmation. The request for confirmation may indicate that the transaction controls were not satisfied, may provide the consumer 108 with the details thereof, and may request confirmation of the consumer 108 if they wish to proceed with the transaction. The consumer 108 may, using the communication device 118, convey confirmation or a decline of the payment transaction, which may be electronically transmitted back to the processing server 102 using a suitable communication network. If the consumer 108 declines, the processing server 102 may proceed to decline the payment transaction. If the consumer 108 confirms, the processing server 102 may ignore the non-compliance with the transaction control and may forward the authorization request on to the issuer system 106. Such an embodiment may be beneficial for instances where a consumer 108 still wants to transact in their home currency, such as if the DCC exchange rate is better than the market rate or contract rate provided by the issuer system 106.

In some embodiments, the processing server 102 may be configured to evaluate the DCC rate for a payment transaction as compared to the market rate or contract rate provided by the issuer system 106 during evaluation of the transaction controls for a transaction. If the evaluation yields that the DCC rate is better than the market rate or contract rate, then the processing server 102 may inform (e.g., via the communication device 118) the consumer 108 of this fact, and provide the consumer 108 with the opportunity to override the transaction control on currency if the home currency was used, or enable the consumer 108 to decline the transaction if local currency was used in order to re-initiate the transaction using their home currency to receive the better rate. In some instances, such ability may be controlled by the issuer system 106 or an entity associated with a transaction account. For example, an entity may not enable an employee to override a transaction control, even when presented with a more favorable rate, such as due to an agreement with the issuer system 106.

### Processing Server

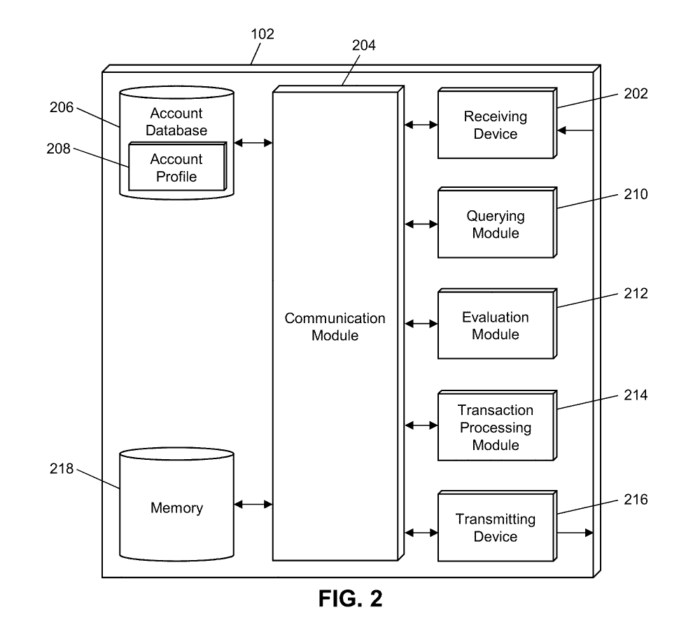

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 800 illustrated in FIG. 8 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 104 for the transmission of transaction messages that include sensitive financial data and information. In some instances, the receiving device 202 may also be configured to receive data from issuer systems 106, payment networks 104, home merchant systems 112, communication devices 118, locating entities 120, local merchant systems 122, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by issuer systems 106 that are superimposed or otherwise encoded with account registration information. Account registration information may include a primary account number, home geographic location 114, and home currency associated with a transaction account and/or payment card 110 for use in the processing of payment transactions involving the respective transaction account and/or payment card 110. In some instances, account registration information may include information identifying a communication device 118 for use in communication with a consumer 108 associated with the account. In some embodiments, the receiving device 202 may also receive data signals electronically transmitted by issuer systems 106 that are superimposed with travel notifications, which may include an indication of a second geographic location 116 where the consumer 108 is traveling, and may also include one or more dates of travel.

The receiving device 202 may also be configured to receive data signals superimposed with travel notifications that are electronically transmitted by the communication device 118 associated with a consumer 108 or a locating entity 120. Such travel notifications may include a primary account number or other identifying information and may indicate the second geographic location 116 and, in some instances, one or more dates of travel. In some embodiments, the receiving device 202 may receive data signals electronically transmitted by the communication device 118 that are superimposed with override confirmations for overriding transaction controls. The receiving device 202 may also be configured to receive transaction messages via the payment network 104. The transaction messages may be related to payment transactions involving home merchant systems 112 and local merchant systems 112 and may be formatted pursuant to one or more standards, including the ISO 8583 standard.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 210, an evaluation module 212, a transaction processing module 214, etc. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a transaction account. Each account profile 208 may include at least a primary account number, an identification value, a first transaction control associated with a geographic location, and a second transaction control associated with a currency. The primary account number may be the number corresponding to the payment card 110 or related transaction account used in conducting payment transactions therewith. The identification value may be any value used in identification of the respective account profile 208, which may be a device identifier associated with a communication device 118 associated with the account, a username, an e-mail address, an identification number, etc. The geographic location and currency transaction controls may be used in the automated management of dynamic currency conversion (DCC) for cross-border transactions, as discussed herein. In some instances, an account profile 208 may include additional data, such as additional transaction controls, communication preferences, account permissions (e.g., for overriding transaction controls), etc.

The processing server 102 may include a querying module 210. The querying module 210 may be configured to execute queries on databases to identify information. The querying module 210 may receive one or more data values or query strings, and may execute a query string based thereon on an indicated database, such as the account database 206, to identify information stored therein. The querying module 210 may then output the identified information to an appropriate engine or module of the processing server 102 as necessary. The querying module 210 may, for example, execute a query on the account database 206 to identify an account profile 208 related to a received transaction message, based on the primary account number stored in the corresponding data element included therein. The querying module 210 may also be configured to execute queries on the account database 206 to update transaction controls, such as based on data included in a travel notification received by the receiving device 202.

The processing server 102 may also include an evaluation module 212. The evaluation module 212 may be configured to evaluate transaction messages and data included therein for compliance with transaction controls associated with a transaction account and/or payment card 110 related to the payment transaction. The evaluation module 212 may receive a transaction message as input, may identify (e.g., via the querying module 210) the related account profile 208, and may evaluate the data stored in the transaction message for compliance with the transaction controls stored in the related account profile 208. The evaluation module 212 may output a result to another module or engine of the processing server 102 that indicates if the evaluation was successful or unsuccessful. The evaluation module 212 may, for example, evaluate a transaction message for a correspondence between a transaction location stored in a corresponding data element to the geographic location included in the respective transaction control in the account profile 208 and for a correspondence between the transacting currency stored in a corresponding data element to the currency included in the respective transaction control in the account profile 208. The evaluation module 212 may also evaluate, for example, authority for a consumer 108 to override transaction controls for a transaction (e.g., based on permissions included in the account profile 208), the use of DCC in a transaction, compliance with additional transaction controls, etc.

The processing server 102 may also include a transaction processing module 214. The transaction processing module 214 may be configured to perform functions related to the processing of payment transaction, including cross-border transactions and transactions involving the use of DCC. The transaction processing module 214 may be configured to receive transaction messages from the payment network 104 and perform functions associated thereto. The transaction processing module 214 may, for example, provide the transaction message and instructions to the evaluation module 212 for evaluation of compliance with transaction controls, and may react to a response provided by the evaluation module 212. For instance, if evaluation of the transaction message is successful, the transaction processing module 214 may perform any additional services related to the transaction (e.g., fraud scoring) prior to instructing a transmitting device 216 to forward the transaction message to the appropriate issuer system 106. If the evaluation is unsuccessful, the transaction processing module 214 may generate a response transaction message (e.g., or modify the received transaction message to be a response transaction message) that includes a message type indicator indicative of an authorization response and a response code indicating that the transaction is declined. In some instances, the transaction processing module 214 may include a response code that indicates that the transaction is declined due to a transaction control, for use of an unapproved currency, for use of DCC, etc. Additional functions performed by the transaction processing module 214 related to the processing of payment transactions will be apparent to persons having skill in the relevant art.

The processing server 102 may also include the transmitting device 216. The transmitting device 216 may be configured to transmit data over one or more networks via one or more network protocols. In some embodiments, the transmitting device 216 may be configured to transmit data over the payment rails, such as using specially configured infrastructure associated with payment networks 104 for the transmission of transaction messages that include sensitive financial data and information, such as identified payment credentials. In some instances, the transmitting device 216 may be configured to transmit data to issuer systems 106, payment networks 104, home merchant systems 112, communication devices 118, locating entities 120, local merchant systems 112, and other entities via alternative networks, such as the Internet. In some embodiments, the transmitting device 216 may be comprised of multiple devices, such as different transmitting devices for transmitting data over different networks, such as a first transmitting device for transmitting data over the payment rails and a second transmitting device for transmitting data over the Internet. The transmitting device 216 may electronically transmit data signals that have data superimposed that may be parsed by a receiving computing device. In some instances, the transmitting device 216 may include one or more modules for superimposing, encoding, or otherwise formatting data into data signals suitable for transmission.

The transmitting device 216 may be configured to electronically transmit data signals to issuer systems 106 that are superimposed with account information related to the management of a transaction account and automated management of DCC. The transmitting device 216 may also be configured to electronically transmit transaction messages to issuer systems 106 via the payment network 104, for use in the processing of payment transactions. The transmitting device 216 may be configured to electronically transmit transaction messages to home merchant systems 112 and local merchant systems 122 or entities associated therewith via the payment network 104 as well, for use in processing payment transactions.

The transmitting device 216 may also be configured to electronically transmit data signals superimposed with confirmation requests to communication devices 118. Confirmation requests may include at least the identifying value included in an account profile 208 and data associated with a payment transaction (e.g., as stored in respective data elements included therein) for use by a consumer 108 in selecting a currency type or overriding controls for a payment transaction. In instances where a consumer 108 may select a different currency than that used in a transaction, the transmitting device 216 may electronically transmit a decline authorization response to a merchant that includes or is accompanying by an indication that the consumer 108 wants to conduct the transaction using an alternative currency. In some such instances, the transaction processing module 214 may generate an alternative authorization request using the alternative currency, which may be forwarded to the issuer system 106 by the transmitting device 216.

The processing server 102 may also include the memory 218. The memory 218 may be configured to store data for use by the processing server 102 in performing the functions discussed herein. The memory 218 may be configured to store data using suitable data formatting methods and schema and may be any suitable type of memory, such as read-only memory, random access memory, etc. The memory 218 may include, for example, currency and geographic location associations, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art.

### Process for Registration for Automated Management of Dynamic Currency Conversion

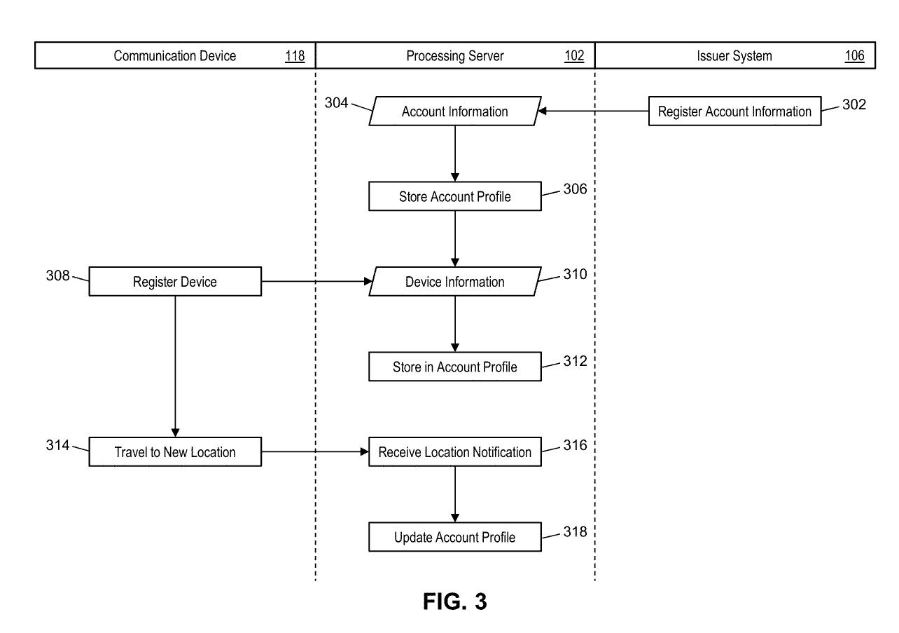

FIG. 3 illustrates a process 300 for the registration of a transaction account for the choice of utilizing automated management of dynamic currency conversion (DCC) in cross-border transactions involving the transaction account, including the updating of transaction controls for the transaction account based on travel notifications for use therewith.

In step 302, the issuer system 106 may submit registration information to register a transaction account with the processing server 102, by electronically transmitting a data signal superimposed or otherwise encoded with the registration information to the processing server 102 using a suitable communication network. In step 304, the receiving device 202 of the processing server 102 may receive the registration information. The registration information may include at least the primary account number and home geographic location 114 associated with the transaction account or a payment card 110 corresponding to the transaction account. In some instances, the registration information may also include a home currency, or the processing server 102 (e.g., via a query on the memory 218 by the querying module 210) may identify the home currency associated with the home geographic location 114. In some embodiments, the registration information may also include an identification value for use in identifying the related transaction account. In step 306, the querying module 210 of the processing server 102 may execute a query on the account database 206 included in the processing server 102 to store a new account profile 208 therein. The new account profile 208 may be related to the transaction account and/or payment card 110 being registered and include the registration information provided by the issuer system 106.

In step 308, the communication device 118 may be registered with the processing server 102. As part of the registration, the communication device 118 may electronically transmit a data signal to the processing server 102 via a suitable communication network that is superimposed with device information. In step 310, the receiving device 202 of the processing server 102 may receive the device information. The device information may include at least the identification value, and may include any additional data suitable for use in communicating with the communication device 118. For example, if the identification value is directly associated with the communication device (e.g., a media access control address, internet protocol address, etc.), the identification value may be used for communication. If the identification value is not directly associated with the communication device (e.g., a username, email address, etc.), the device information may include a device identifier or other information suitable for use in identifying the communication device 118 for delivery of data signals and other messages thereto. For example, the consumer 108 may submit, via the communication device 118, communication preference data, which may indicate if the consumer 108 prefers to receive messages via short message service, e-mail, telephone, etc., which may be used by the processing server 102 in communications with the consumer 108 via the communication device 118. In some instances, the registration by the issuer system 106 and/or by the consumer 108 via the communication device 118 may include an indication that the transaction account and/or payment card 110 is being opted-in to the automated management of DCC. In step 312, the querying module 210 of the processing server 102 may execute a query on the account database 206 to update the account profile 208 that includes the identification value provided with the device information to store the additional information provided.

In step 314, the consumer 108 may travel with the communication device 118 to a second geographic location 116. In step 316, the receiving device 202 of the processing server 102 may receive a data signal superimposed with a travel notification, which may include at least the identification value and/or primary account number and the second geographic location 116 or a location included therein or associated therewith. In one embodiment, the data signal may be electronically transmitted by the communication device 118. In another embodiment, a locating entity 120 may obtain the geographic location of the communication device 118 using a suitable method, such as the methods described in U.S. patent application Ser. No. 14/790,282, entitled “Method and System for Cross-Border Travel Alerts,” filed on Jul. 2, 2015, and U.S. patent application Ser. No. 14/755,262, entitled “Method and System for Fraud Control Based on Geolocation,” filed on Jun. 30, 2015, which are both herein incorporated by reference in their entirety, and may electronically transmit the data signal to the processing server 102. In yet another embodiment, the issuer system 106 may obtain the geographic location of the communication device 118 or consumer 108 and may electronically transmit the data signal to the processing server 102. In still another embodiment, the travel notification may be received as a transaction message for an attempted transaction using the payment card 110 received via the payment network 104.

Once the travel notification has been received, then, in step 318, the querying module 210 of the processing server 102 may execute a query on the account database 206 to update, in the account profile 208 that includes the identification value or primary account number included in the travel notification, the transaction control for the geographic location to include the second geographic location 116 and the transaction control for currency to include a local currency associated with the second geographic location 116. In some instances, the querying module 210 may execute a query on the memory 218 of the processing server to identify the local currency associated with the second geographic location 116. In some embodiments, the process may further include the transmitting, by the transmitting device 216 of the processing server, of a data signal to the issuer system 106 and/or communication device 118 superimposed with a notification that the account profile 208 has been automatically updated due to the travel, such that any cross-border transactions in the second geographic location 116 will be prevented from use of DCC.

Processing of Cross-Border Transactions with Automated Management of Dynamic Currency Conversion

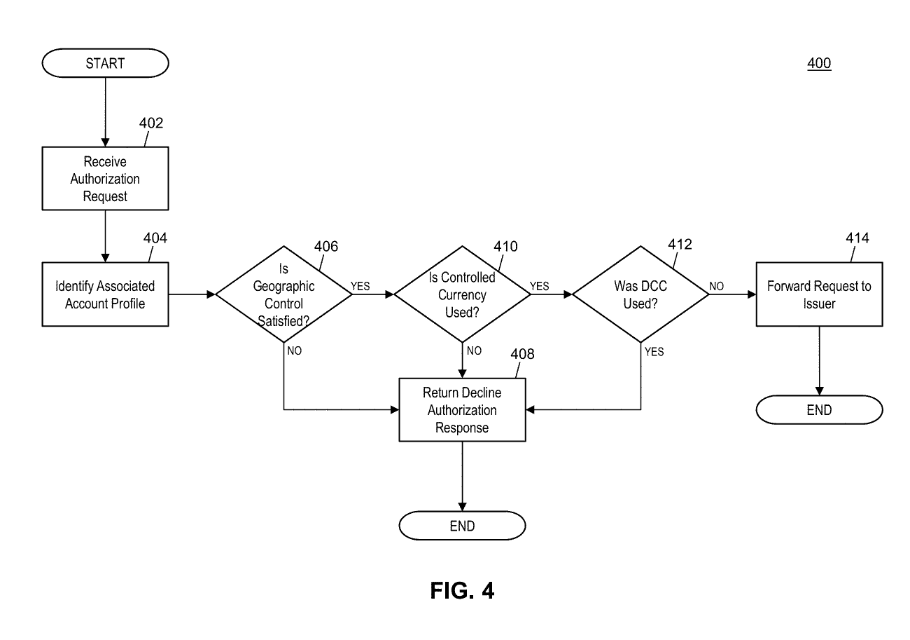

FIG. 4 illustrates a process 400 for the processing of a cross-border transaction that involves automated management of the use of dynamic currency conversion (DCC) using the processing server 102 via transaction controls.

In step 402, the receiving device 202 of the processing server 102 may receive an authorization request for a cross-border transaction. The authorization request may be a transaction message formatted pursuant to one or more standards, such as the ISO 8583 standard, that includes a message type indicator indicative of an authorization request. The authorization request may also include a plurality of data elements including at least a first data element configured to store a primary account number, a second data element configured to store a transacting location corresponding to a geographic location where the transaction was conducted, a third data element configured to store a transacting currency, and one or more additional data elements configured to store additional transaction data. Additional transaction data may include, for example, an indication of the transaction as a cross-border transaction, and indication of whether or not DCC is used in the transaction, a transaction amount, a transaction time, a transaction date, merchant data, point of sale data, consumer data, reward data, loyalty data, product data, offer data, issuer data, acquirer data, etc.

In step 404, the querying module 210 of the processing server 102 may execute a query on the account database 206 of the processing server 102 to identify an account profile 208 related to the transaction account used in the payment transaction corresponding to the received authorization request. The identified account profile 208 may be identified via the inclusion of a primary account number that corresponds to the primary account number stored in the corresponding data element included in the received authorization request.

In step 406, the processing server 102 may determine if the payment transaction satisfies the transaction control on geographic location stored in the identified account profile 208. The determination may be made based off of an evaluation by the evaluation module 212 of the processing server 102 of a correspondence between the transacting location stored in the corresponding data element included in the received authorization request and the geographic location stored in the corresponding transaction control included in the identified account profile 208. If the evaluation is unsuccessful, and thus determined that the payment transaction does not satisfy the transaction control, then, in step 408, the transaction processing module 214 of the processing server 102 may generate a declining authorization response that is electronically transmitted, by the transmitting device 216 of the processing server, to the merchant or associated intermediate entity via the payment network 104. The declining authorization response may be a transaction message, including a modification of the authorization request, that includes a message type indicator indicative of an authorization response that also includes a data element configured to store a response code that indicates that the transaction is declined. In some instances, the response code may further indicate that the transaction was declined due to a transaction control and/or the transacting location.

If the evaluation in step 406 is successful, and thus determined that the payment transaction does satisfy the transaction control, then the process 400 may proceed to step 410 where the processing server 102 may determine if the currency used in the transaction satisfies the transaction control on currency for the transaction account. The determination may be based off of an evaluation by the evaluation module 212 of the processing server 102 of a correspondence between the transaction currency stored in the corresponding data element included in the received authorization request and the currency stored in the corresponding transaction control included in the identified account profile 208. If the evaluation is unsuccessful, and thus determined that an unapproved currency was used, then the process 400 may proceed to step 408 where a declining authorization response is returned by the processing server 102.

If the evaluation is successful, and thus determined that an authorized currency was used, then the process 400 may proceed to step 412 where the processing server 102 may determine if DCC was used in the transaction. The determination may be based off of an evaluation by the evaluation module 212 of the processing server 102 of a data element included in the authorization request configured to store an indication of whether or not DCC is used in the transaction. If the data element indicates that DCC was used or is to be used, then the process 400 may proceed to step 408 where a declining authorization response is returned, which may include a response code indicating that the transaction was declined due to unauthorized use of DCC. If the data element indicates that DCC is not used in the transaction, then the process may proceed to step 414, where the transmitting device 216 of the processing server 102 may forward the authorization request on to the issuer system 106 associated with the transaction account via the payment network 104. In some embodiments, the payment transaction may be subject to additional transaction controls or other services prior to or in lieu of forwarding of the authorization request to the issuer system 106.

In embodiments where the consumer 108 associated with the transaction account and/or payment card 110 used in the payment transaction may be authorized to override a transaction control or use of DCC, the process 400 may include one or more steps preceding step 408. For instance, prior to the returning of a declining authorization response, the transmitting device 216 of the processing server 102 may first electronically transmit a data signal to the communication device 118 associated with the identified account profile 208 as indicated therein that is superimposed with a confirmation request. The receiving device 202 of the processing server 102 may receive a response indicating if the transaction is to be declined or if the consumer 108 confirms that the transaction is to proceed despite the determination. If the transaction is to be declined, then step 408 may be performed as discussed above. If the consumer 108 confirms that the transaction is to proceed, the process 400 may proceed to the next step following the determination, as illustrated in FIG. 4 and discussed above.

### Exemplary Method for Automated Management of Dynamic Currency Conversion

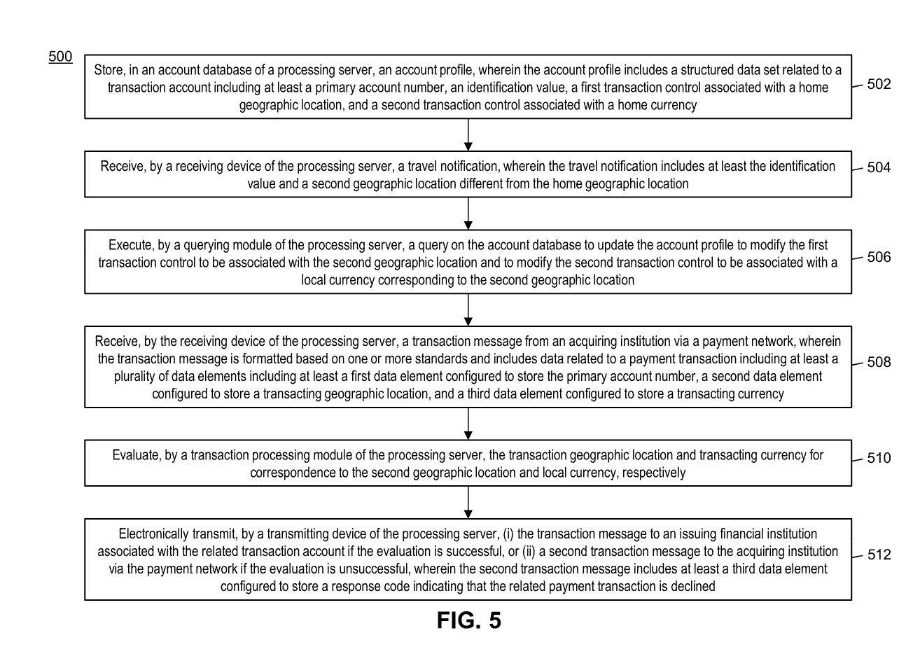

FIG. 5 illustrates a method 500 for the automated management of dynamic currency conversion (DCC) in a cross-border transaction via the use of transaction controls for geographic location and currency updated based on travel notifications associated with a transaction account.

In step 502, an account profile (e.g., account profile 208) may be stored in an account database (e.g., the account database 206) of a processing server (e.g., the processing server 102), wherein the account profile includes a structured data set related to a transaction account including at least a primary account number, an identification value, a first transaction control associated with a home geographic location (e.g., the home geographic location 114), and a second transaction control associated with a home currency. In step 504, a travel notification may be received by a receiving device (e.g., the receiving device 202) of the processing server, wherein the travel notification includes at least the identification value and a second geographic location (e.g., the second geographic location 116) different from the home geographic location.

In step 506, a query may be executed on the account database by a querying module (e.g., the querying module 210) of the processing server to update the account profile to modify the first transaction control to be associated with the second geographic location and to modify the second transaction control to be associated with a local currency corresponding to the second geographic location. In step 508, a transaction message may be received by the receiving device of the processing server from an acquiring institution via a payment network (e.g., the payment network 104), wherein the transaction message is formatted based on one or more standards and includes data related to a payment transaction including at least a plurality of data elements including at least a first data element configured to store the primary account number, a second data element configured to store a transacting geographic location, and a third data element configured to store a transacting currency.

In step 510, a transaction processing module (e.g., the transaction processing module 214) or evaluation module (e.g., the evaluation module 212) of the processing server may evaluate the transaction geographic location and transacting currency for correspondence to the second geographic location and local currency, respectively. In step 512, a transmitting device (e.g., the transmitting device 216) of the processing server 102 may electronically transmit (i) the transaction message to an issuing financial institution (e.g., the issuer system 106) associated with the related transaction account if the evaluation is successful, or (ii) a second transaction message to the acquiring institution via the payment network if the evaluation is unsuccessful, wherein the second transaction message includes at least a third data element configured to store a response code indicating that the related payment transaction is declined.

In one embodiment, the identification value may be a device identifier associated with a mobile communication device (e.g., the communication device 118), and the travel notification may indicate that the mobile communication device is located in the second geographic location. In some embodiments, the primary account number and the identification value may be the same value, and the travel notification may comprise an additional transaction message associated with a declined payment transaction, where the identification value and second geographic location are stored in data elements included therein.

In one embodiment, the authorization request may further include a fourth data element configured to store an indication of whether or not dynamic currency conversion is performed for the related payment transaction. In a further embodiment, the evaluation may be unsuccessful if dynamic currency conversion is performed. In one embodiment, the response code may indicate that the related payment transaction was declined due to the transacting currency. In some embodiments, the one or more standards may include the ISO 8583 standard.

In one embodiment, the method 500 may further include: electronically transmitting, by the transmitting device of the processing server, a confirmation request to a mobile communication device associated with the related transaction account, wherein the confirmation request includes at least the transacting currency; and receiving, by the receiving device of the processing server, a confirmation response from the mobile communication device, wherein the confirmation response includes at least a confirmation or a decline associated with the related transaction, and the evaluation is unsuccessful if the confirmation request includes a decline associated with the related transaction. In a further embodiment the mobile communication device may be associated with the identification value. In another further embodiment, if the confirmation request includes a confirmation associated with the related transaction, evaluation of the transacting currency for correspondence to the local currency may always be successful.

### Payment Transaction Processing System and Process

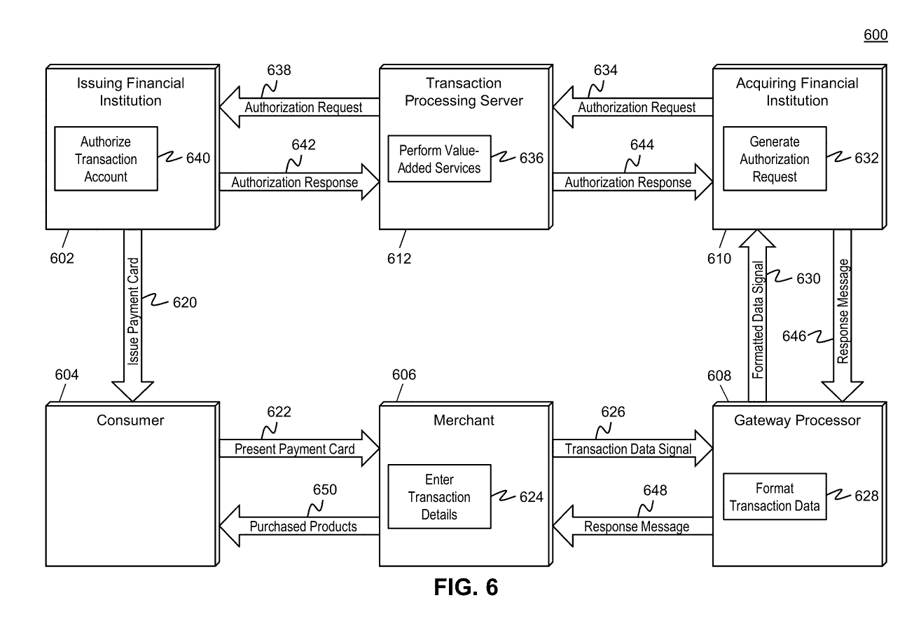

FIG. 6 illustrates a transaction processing system and a process 600 for the processing of payment transactions in the system. The process 600 and steps included therein may be performed by one or more components of the system 100 discussed above, such as the processing server 102, payment network 104, issuer system 106, consumer 108, home merchant system 112, local merchant system 122, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3-5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the

International Organization for Standardization's ISO 8683 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8683 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 650, assuming the transaction was approved, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 602. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for automated management of dynamic currency conversion in a cross-border transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for automated management of dynamic currency conversion in a cross-border transaction, comprising:
storing, in an account database of a processing server, an account profile, wherein the account profile includes a structured data set related to a transaction account including at least a primary account number, an identification value, a first transaction control associated with a home geographic location, and a second transaction control associated with a home currency;
receiving, by a receiving device of the processing server, a travel notification, wherein the travel notification includes at least the identification value and a second geographic location different from the home geographic location;
executing, by a querying module of the processing server, a query on the account database to update the account profile to modify the first transaction control to be associated with the second geographic location and to modify the second transaction control to be associated with a local currency corresponding to the second geographic location;
receiving, by the receiving device of the processing server, a transaction message from an acquiring institution via a payment network, wherein the transaction message is formatted based on one or more standards and includes data related to a payment transaction including at least a plurality of data elements including at least a first data element configured to store the primary account number, a second data element configured to store a transacting geographic location, and a third data element configured to store a transacting currency;
evaluating, by a transaction processing module of the processing server, the transaction geographic location and transacting currency for correspondence to the second geographic location and local currency, respectively; and
electronically transmitting, by a transmitting device of the processing server, (i) the transaction message to an issuing financial institution associated with the related transaction account if the evaluation is successful, or (ii) a second transaction message to the acquiring institution via the payment network if the evaluation is unsuccessful, wherein the second transaction message includes at least a third data element configured to store a response code indicating that the related payment transaction is declined.

2. The method of claim 1, wherein
the identification value is a device identifier associated with a mobile communication device, and
the travel notification indicates that the mobile communication device is located in the second geographic location.

3. The method of claim 1, wherein
the primary account number and the identification value are a same value, and
the travel notification comprises an additional transaction message associated with a declined payment transaction, where the identification value and second geographic location are stored in data elements included therein.

4. The method of claim 1, wherein the authorization request further includes a fourth data element configured to store an indication of whether or not dynamic currency conversion is performed for the related payment transaction.

5. The method of claim 4, wherein the evaluation is unsuccessful if dynamic currency conversion is performed.

6. The method of claim 1, wherein the response code indicates that the related payment transaction was declined due to the transacting currency.

7. The method of claim 1, further comprising:
electronically transmitting, by the transmitting device of the processing server, a confirmation request to a mobile communication device associated with the related transaction account, wherein the confirmation request includes at least the transacting currency; and
receiving, by the receiving device of the processing server, a confirmation response from the mobile communication device, wherein
the confirmation response includes at least a confirmation or a decline associated with the related transaction, and
the evaluation is unsuccessful if the confirmation request includes a decline associated with the related transaction.

8. The method of claim 7, wherein the mobile communication device is associated with the identification value.

9. The method of claim 7, wherein, if the confirmation request includes a confirmation associated with the related transaction, evaluation of the transacting currency for correspondence to the local currency is always successful.

10. The method of claim 1, wherein the one or more standards includes the ISO 8583 standard.

11. A system for automated management of dynamic currency conversion in a cross-border transaction, comprising:
a transaction processing module of a processing server;
a transmitting device of the processing server;
an account database of the processing server configured to store an account profile, wherein the account profile includes a structured data set related to a transaction account including at least a primary account number, an identification value, a first transaction control associated with a home geographic location, and a second transaction control associated with a home currency;
a receiving device of the processing server configured to receive a travel notification, wherein the travel notification includes at least the identification value and a second geographic location different from the home geographic location; and
a querying module of the processing server configured to execute a query on the account database to update the account profile to modify the first transaction control to be associated with the second geographic location and to modify the second transaction control to be associated with a local currency corresponding to the second geographic location, wherein
the receiving device of the processing server is further configured to receive a transaction message from an acquiring institution via a payment network, wherein the transaction message is formatted based on one or more standards and includes data related to a payment transaction including at least a plurality of data elements including at least a first data element configured to store the primary account number, a second data element configured to store a transacting geographic location, and a third data element configured to store a transacting currency,
the transaction processing module of the processing server is configured to evaluate the transaction geographic location and transacting currency for correspondence to the second geographic location and local currency, respectively, and
the transmitting device of the processing server is configured to electronically transmit (i) the transaction message to an issuing financial institution associated with the related transaction account if the evaluation is successful, or (ii) a second transaction message to the acquiring institution via the payment network if the evaluation is unsuccessful, wherein the second transaction message includes at least a third data element configured to store a response code indicating that the related payment transaction is declined.

12. The system of claim 11, wherein
the identification value is a device identifier associated with a mobile communication device, and
the travel notification indicates that the mobile communication device is located in the second geographic location.

13. The system of claim 11, wherein
the primary account number and the identification value are a same value, and
the travel notification comprises an additional transaction message associated with a declined payment transaction, where the identification value and second geographic location are stored in data elements included therein.

14. The system of claim 11, wherein the authorization request further includes a fourth data element configured to store an indication of whether or not dynamic currency conversion is performed for the related payment transaction.

15. The system of claim 14, wherein the evaluation is unsuccessful if dynamic currency conversion is performed.

16. The system of claim 11, wherein the response code indicates that the related payment transaction was declined due to the transacting currency.

17. The system of claim 11, wherein
the transmitting device of the processing server is further configured to electronically transmit a confirmation request to a mobile communication device associated with the related transaction account, wherein the confirmation request includes at least the transacting currency,
the receiving device of the processing server is further configured to receive a confirmation response from the mobile communication device,
the confirmation response includes at least a confirmation or a decline associated with the related transaction, and
the evaluation is unsuccessful if the confirmation request includes a decline associated with the related transaction.

18. The system of claim 17, wherein the mobile communication device is associated with the identification value.

19. The system of claim 17, wherein, if the confirmation request includes a confirmation associated with the related transaction, evaluation of the transacting currency for correspondence to the local currency is always successful.

20. The system of claim 11, wherein the one or more standards includes the ISO 8583 standard.
